(19) United States
(12) Patent Application Publication
(10) Pub. No.: US 2021/0354167 A1
(43) Pub. Date: Nov. 18, 2021

(54) MODULAR COATING DRUM

(71) Applicant: THOMAS ENGINEERING LLC, Elgin, IL (US)

(72) Inventor: Timothy C. Pilipauskas, Arlington Heights, IL (US)

(73) Assignee: THOMAS ENGINEERING LLC, Elgin, IL (US)

(21) Appl. No.: 17/313,104

(22) Filed: May 6, 2021

Related U.S. Application Data
(60) Provisional application No. 63/024,263, filed on May 13, 2020.

(51) Int. Cl. B05C 9/02; B05D 1/00; B05C 11/00

(52) U.S. Cl. CPC B05C 9/02; B05C 11/00; B05D 1/002

(57) ABSTRACT

A modular coating drum for use in a production or laboratory coater for coating a material with a solution or a suspension. The modular coating drum includes a perforated sidewall between two removable drum end plates, each of the drum end plates attached to an end of the perforated sidewall by a releasable fastener. The drum end plates can be used with two different sizes of sidewalls.

### CROSS REFERENCE TO RELATED APPLICATION

This Application claims the benefit of U.S. Provisional Patent Application Ser. No. 63/024,263, filed on 13 May 2020. The co-pending U.S. Provisional Patent Application is hereby incorporated by reference herein in its entirety and is made a part hereof, including but not limited to those portions which specifically appear hereinafter.

### BACKGROUND OF THE INVENTION

### Field of the Invention

This invention generally relates to a coating drum for a coater, e.g., a production or a laboratory coater, for coating a material to be coated with a solution or a suspension, and more particularly to a modular coating drum apparatus and method that allows, as an example, for coating different tablet batch sizes in a single coating machine.

### Discussion of Related Art

Typical tablet coating machines use several different drums to achieve varying batch sizes. A typical drum can only be used over a limited range of batch sizes. To run with a wider range of batches, a typical user will have different drums of different sizes. In many coaters on the market, drums of different sizes can be changed with one another.

These drums are constructed of a solid, perforated, or slotted, etc., middle section which is fully welded to and between two end pieces, one with an opening to load the tablets in and the other to attach to the main drive. These end pieces can be formed tank heads of varying sizes and shapes or formed sheet metal conical ends. The drums also could include automatic unloading or mixing features fully welded into the drum either onto the perforations or onto the ends of the drum. The different processes and tablet batch sizes will dictate which features are included in the coating drum.

Tablet coating different pharmaceutical products requires testing and experimentation in order to perfect the process. In addition, production coating often uses a wide range of batch sizes. Each of these situations usually requires multiple drum options for the end user which can get costly and take up storage space in the coating room which is typically limited due to its highly sterile environment. Therefore, a need exists to maximize batch size and drum geometry options while decreasing cost and storage space.

### SUMMARY OF THE INVENTION

This invention provides and includes a modular coating drum for a coater. A coater of this invention is a machine for coating a material with a solution or suspension. In an embodiment of this invention, the coater includes a cabinet forming an outer housing. The cabinet encloses a removable coating drum positioned within the cabinet. The drum is preferably releasably connectable to a motor drive that rotates the drum. The coating drum can also include a baffle and/or a divider in an interior of the coating drum to improve the design of the drum to agitate cores, solutions and/or suspensions within the drum to ensure adequate coverage of the cores.

The invention provides a modular coating drum including a sidewall (e.g., solid, perforated, or slotted) between two drum end plates, at least one of the drum end plates being removeable and attached to an end of the sidewall by at least one releasable fastener. The sidewall is preferably and typically cylindrical, and each of the two drum end plates has a corresponding circular peripheral circumference. The releasable fastener can be, for example, a bolt, a hand knob, or a partial-turn fastener.

Embodiments of the present invention include, for example, a 2 or 3 piece modular coating drum. The rear end section will preferably be constructed as a conical or formed dished head with a common mounting plate to attach to a universal drive shaft. The front section will also preferably be constructed as a conical or formed dished head and will include the drum opening for tablet loading, coating mechanisms, optional unloading mechanisms, sampling features, and several different geometries for different types of mixing. The section will be in varying lengths to achieve multiple batch sizes. This section can include features for unloading and baffle mounting options for mixing.

In embodiments of this invention, one or more ends of the sidewall can have the drum end plate exchanged and/or substituted with a second, different drum end plate. This can allow a same sidewall to be used for more than one product batch. As an example, coating an older product may require one particular drum shape, such as due to internal and/or FDA approval/validation for a coating process. The user can use one drum configuration for the older batch, and a new, different drum end plate configuration for a new product coating, using the same sidewall and different drum plate ends.

The sections of the drum when assembled will desirably be flush and cleanable with no crevices in accordance with GMP guidelines. Different types of fasteners can be used to join the end sections. With this modular approach, many different drum types can be assembled using minimal parts and space and at less cost than using different size drums.

The invention further provides a coating drum apparatus for a coater for coating a material with a solution or a suspension. The coating drum apparatus includes a first sidewall having a first size (e.g., length) between a two opposing open first sidewall ends and a second sidewall having a second size (e.g., length) between two opposing open second sidewall ends, the second size being different than the first length. The coating drum apparatus further includes a pair of removable drum end plates. Each of the drum end plates is removably connectable to, and exchangeable between, one of the first sidewall ends and one of the second sidewall ends.

The coating drum apparatus can further includes a third sidewall having a third size (e.g., length) between two opposing open third sidewall ends, the third size being different than each of the first size and the second size. Each of the drum end plates is also removably connectable to one of the third sidewall ends.

The invention further includes a method of operating a coater for coating a material with a solution or a suspension. The method includes: assembling a first rotatable drum by connecting each of a pair of removable drum end plates to one of opposing first sidewall ends of a first sidewall having a first length between the opposing first ends; inserting the first rotatable drum into the coater; rotating the first rotatable drum to coat the material within the coater; removing the first rotatable drum from the coater; and removing each removable drum end plate for storage of the first sidewall. The method can further include steps of: assembling a second rotatable drum by connecting the each of the pair of removable drum end plates to one of opposing second sidewall ends of a second sidewall having a second length between the opposing second sidewall ends, the second length being different than the first length; and inserting the second rotatable drum into the coater.

### BRIEF DESCRIPTION OF THE DRAWINGS

These and other objects and features of this invention will be better understood from the following detailed description taken in conjunction with the following generalized and simplified drawings.

FIGS. 1 and 2 each show an exemplary known coater.

FIG. 3 shows a perspective view of a modular coating drum according to one embodiment of this invention.

FIG. 4 is an exploded disassembled view of the modular coating drum according to FIG. 3.

FIGS. 5A and 5B each show an exemplary biconical coating drum end plate according to one embodiment of this invention.

FIGS. 6A and 6B each show an exemplary shallow angle biconical coating drum end plate according to one embodiment of this invention.

FIGS. 7A and 7B each show an exemplary cylindrical style coating drum end plate according to one embodiment of this invention.

FIG. 8 shows a perforated sidewall without baffle features according to one embodiment of this invention.

FIG. 9 shows a perforated sidewall with baffle features according to one embodiment of this invention.

FIG. 10 shows an exemplary quarter-turn locking handle according to one embodiment of this invention.

FIG. 11 shows a hand knob fastener according to one embodiment of this invention.

FIGS. 12-16 each shows a modular coating drum variation according to one embodiment of this invention.

### DETAILED DESCRIPTION OF THE INVENTION

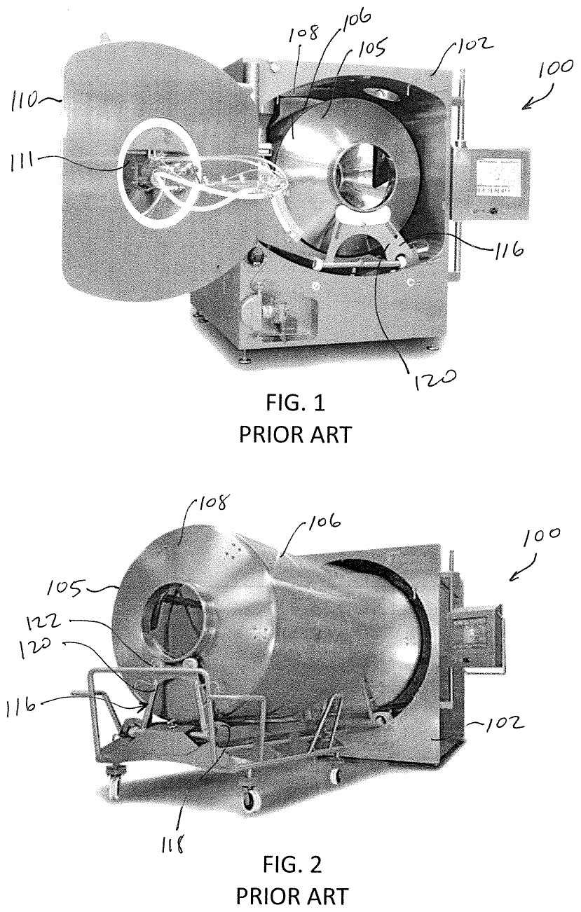

FIGS. 1 and 2 each show an exemplary coater 100 with an exchangeable drum system 105. The coater 100 is a machine for coating pharmaceutical tablets and similar applications, preferably with a solution or a suspension. The coater 100 is preferably a production scale coater capable of production in the range of approximately 30 liters to approximately 1,200 liters of material per batch. However, the coater 100 should not be limited to this range and may include of any volume. Each coater 100 preferably includes a housing 102 and a motor drive unit, not shown, capable of rotating the exchangeable drum system 105. The drum system includes a perforated cylindrical section 106 welded to two end sections 108. The drum system will be described herein with reference to a perforated sidewall, but a solid, slotted, etc. sidewall can also be used, depending on need.

The housing 102 is preferably configured to provide a sealed, sanitary enclosure for the mixing and coating operation. According to a preferred embodiment of this invention, the coater 100 may further include front access to an interior of the housing 102 through access door 110 and/or an optional process port 111 positioned within access door 110. In such a manner, the front of coater 100 preferably opens to provide full access to the exchangeable drum 105 for extraction, insertion, inspection, baffles access, cleaning, maintenance and cleaning validation.

In a preferred embodiment, a plurality of rollers 118 may be positioned along a cradle 116 to permit the cradle 116, with the drum 105, to slide in and out of the housing 102. In an embodiment of this invention, following removal of the exchangeable drum 105 from the housing, a different drum with a different production capacity may be swapped onto the cradle 116 and placed in the coater 100. In another embodiment, as shown in FIG. 2, the drum 105 and cradle 116 are both removed as a drum system, and following removal of the exchangeable drum system, another exchangeable drum system with another cradle and drum may be positioned within and operationally connected to the coater 100. Replacement of the exchangeable drum may be facilitated with a drive shaft decoupling, either manual or automated.

In an embodiment of this invention, the cradle 116 preferably accommodates a support 120 which may be integrated with the cradle 116. Alternatively, the support may be separate from the cradle and may be connected to the coater as a trunnion bar. The support 120 is preferably configured to permit rotation of an access end of drum 105. As shown in FIG. 2, the support 120 includes drum rollers 122. In addition, the cradle 116 may include a slot or similar accommodation for a drive end of the drum 105, specifically a drive shaft or coupling.

The coater end user typically has multiple drum options, which can get costly and take up storage space in coating rooms that are often limited due to its highly sterile environment. The invention includes a modular drum, which can be easily disassembled and reassembled to improve storage. In embodiments of this invention, a same set of end caps can be assemble to multiple size drum cylinders to further promote storage space and overall costs.

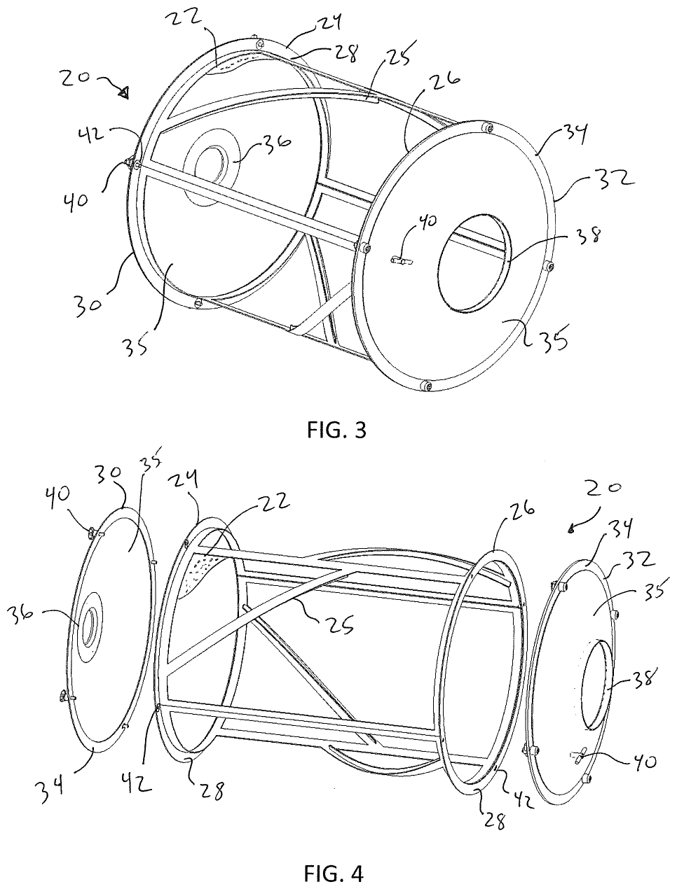

FIGS. 3 and 4 show a modular coating drum 20 according to one embodiment of this invention. The modular coating drum 20 includes a perforated sidewall 22 between two removable drum end plates 30 and 32. In the figures, the full sidewall 22 is removed to allow internal viewing. One, and preferably both, of the drum end plates 30 and 32 is removably attached to a corresponding end 24 and 26 of the perforated sidewall 22 by a releasable fastener 40. The modular coating drum 20, when assembled, can be placed within the coater, such as shown in FIGS. 1 and 2.

The cylindrical sidewall 22 includes a circular sidewall flange 28 at each end 24 and 26, extending perpendicularly outward, and for abutting the corresponding end plate 30 and 32, and including an integral or separate receiver 42 (e.g., a threaded opening or equivalent) for a counterpart releasable fastener 40. Each of the two drum end plates 30 and 32 has a circular peripheral circumference with an end wall flange 34 for attaching to the sidewall flange 28.

The drum 20 further includes a plurality of baffles 25. The vented perforated sidewall 22 preferably provides a way for expelling exhaust from the interior of the drum 20 to an exhaust plenum or equivalent without the cores being able to escape the drum 20. The baffles 25 generally are used to improve the coating process. The drums of this invention may further include various levels of polishing, multiple perforation patterns, various perforation sizes and shapes and/or various types of mixing baffles and anti-slide bars. Such multiple configuration enable replaceable drums to match perforation size and shape to various substrates, processes and wash requirements; match perforation pattern to various structural requirements; and permit the processing of tablets, granules, beads, very small tablets and/or other objects. Drums may further include meshed perforations.

The end plates 30 and 32 each further include a shaped end 35 extending outward from the end wall flange 34 to a drive end 36 in end plate 30 and an access opening 38 in end plate 32. The shaped ends 35 can be the same or different, and can be straight or curved. The shaped ends 35 preferably have a truncated cone or a frusto-conical shape. The access opening 38 provides access to an interior of the drum 20 and the drive end 36 is connectable with the coater motor drive, preferably via a removeable coupling, on the opposite side of drum from access opening 38.

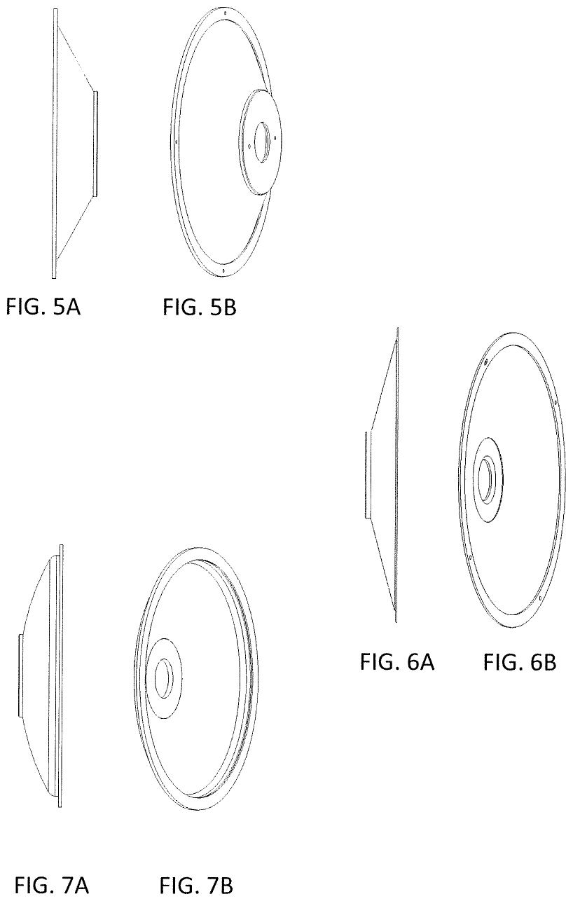

FIGS. 5A and B show an embodiment of biconical shaped coating drum ends. FIGS. 6A and B show shallow angle biconical drum ends. FIGS. 7A and B show rounded or cylindrical shaped ends, having curved walls instead of straight. The drum and components thereof according to this this invention are not limited to these shapes and may comprise any shape which allows the drum to coat pharmaceutical tablets and similar applications with a solution or a suspension.

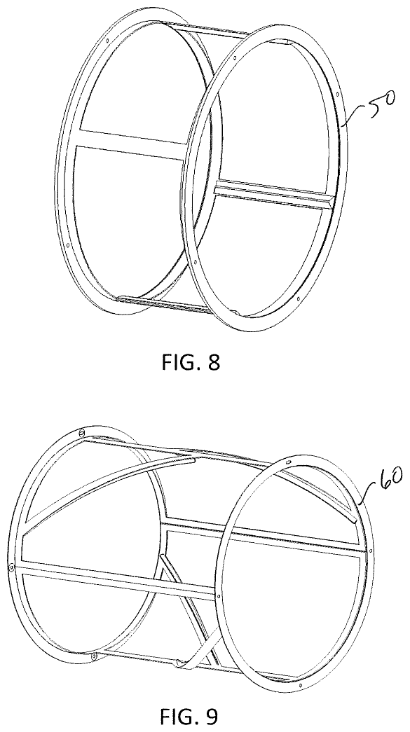

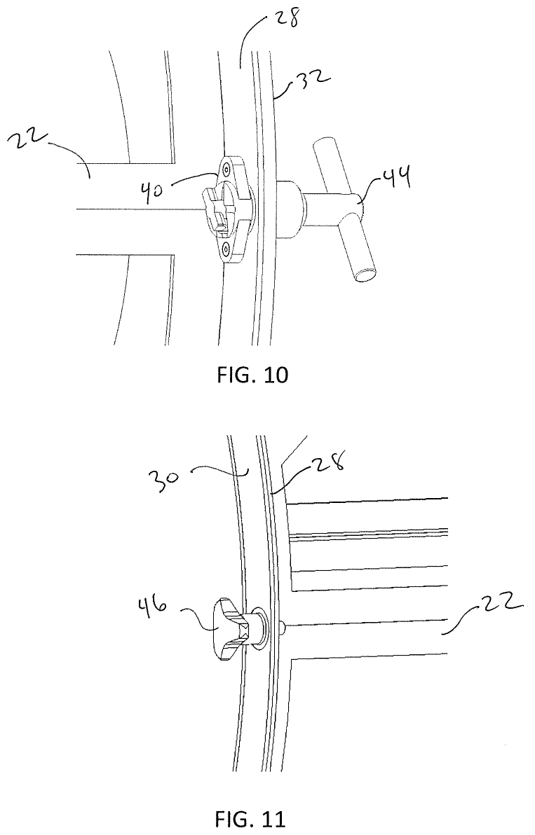

In preferred embodiments of this invention, each of the drum end plates 30 and 32 is removably connectable to, and exchangeable between, a first sidewall and a second sidewall of a different size (e.g., length and/or diameter). FIGS. 8 and 9 show two alternatively sized perforated sidewalls 50 and 60, with the sidewall 50 of FIG. 8 having a shorter length than the sidewall 60 of FIG. 9, which itself is shorter than the sidewall 20 of FIGS. 1-2. FIG. 8 also shows an optional embodiments without mixing/unloading baffles. Each of these sidewalls can be used with a same or different set of end walls described herein, which allows for improved storage and flexibility. The end wall flanges can also be side or otherwise configured to allow for two different diameter sidewalls, such as having a narrower fastener attachment position and a wider fastener attachment position on a same, wider flange. The sidewall can also be dividable, such as being releasably dividable in half to allow a smaller storage space by stacking the halves into one another. The parts can be combined by any suitable connection means, such as, without limitation, a releasable fastener selected from a bolt, a hand knob, or a partial-turn fastener. FIG. 10 shows an exemplary quarter-turn, spring loaded cam locking handle 44, and a counterpart receiver 42. FIG. 11 shows an exemplary hand knob assembly 46, such as with locking threads.

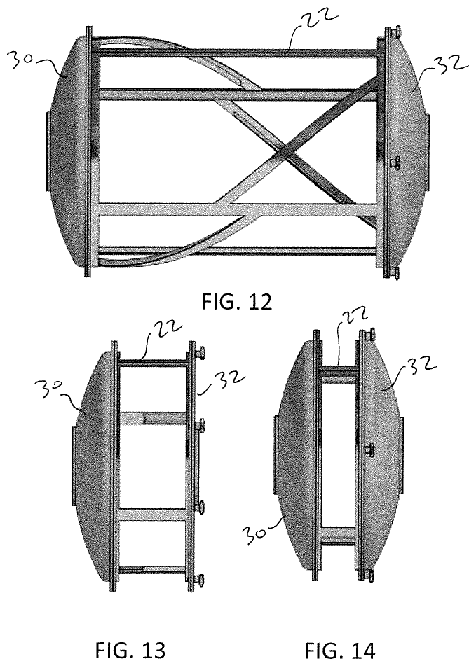

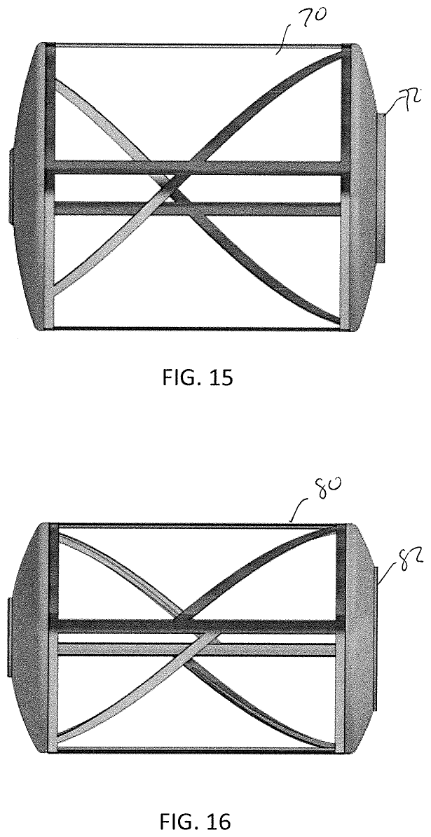

FIGS. 12-14 each show an alternative drum embodiment, differing for example in length and/or end plate shape, according to embodiments of this invention. Each is shown as having on end plate 30 as welded, and a second end plate 32 as releasably fastened according to this invention, but each end plate can optionally be removable as well. FIG. 13 also shows an embodiment where one end plate 32 is flat or planar. FIGS. 15 and 16 show alternative exemplary drum embodiments 70 and 80 that differ in diameter and/or access opening 72, 82 size.

Thus the invention provides a modular drum system with sharable components that promote storage space savings and/or reduced costs.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. In a coater for coating a material with a solution or a suspension, the coater comprising a housing cabinet with a motor drive for receiving and rotating a coating drum releasably connectable to the motor drive within the cabinet, the improvement comprising:
a modular coating drum including a sidewall between two drum end plates, at least one of the drum end plates being removable and attached to an end of the sidewall by a releasable fastener.

2. In the coater of claim 1, wherein the sidewall is cylindrical and each of the two drum end plates has a circular peripheral circumference.

3. In the coater of claim 1, wherein a first of the drum end plates comprises a motor drive coupling, and a second of the drum end plates comprises an access opening.

4. In the coater of claim 1, further comprising an exchangeable drum end plate for one of the at least one drum end plates, wherein the exchangeable drum end plate can be substituted for the one of the at least one drum end plates on the end of the sidewall by the releasable fastener.

5. In the coater of claim 1, wherein at least one of the drum end plates comprises a truncated cone or a frusto-conical shape.

6. In the coater of claim 1, wherein the releasable fastener comprises a bolt, a hand knob, or a partial-turn fastener.

7. In the coater of claim 1, further comprising:
a second sidewall having a length that is different than the sidewall, wherein the two removable drum end plates connect to each of the sidewall and the second sidewall.

8. A coating drum apparatus for a coater for coating a material with a solution or a suspension, the coating drum apparatus comprising:
a first sidewall having a first length between a two opposing open first sidewall ends;
a second sidewall having a second length between two opposing open second sidewall ends, the second length different than the first length; and
a pair of removable drum end plates, wherein each of the drum end plates is removably connectable to, and exchangeable between, one of the first sidewall ends and one of the second sidewall ends.

9. The coating drum apparatus of claim 8, wherein each of the first and second sidewalls is cylindrical and each of the drum end plates has a circular peripheral circumference.

10. The coating drum apparatus of claim 8, wherein a first of the drum end plates is a driven end plate including a motor drive coupling configured to connect to a motor drive of the coater.

11. The coating drum apparatus of claim 10, wherein a second of the drum end plates comprises an access opening.

12. The coating drum apparatus of claim 11, wherein the first of the drum plates comprises a first truncated cone or a frusto-conical shape between a first circular outer peripheral circumference and the motor drive coupling, and the first of the drum plates comprises a second truncated cone or a frusto-conical shape between a second circular outer peripheral circumference and the access opening.

13. The coating drum apparatus of claim 8, wherein the drum end plates are connected to and removable from each of the first and second sidewall by a plurality of releasable fasteners.

14. The coating drum apparatus of claim 13, wherein the releasable fasteners comprise a bolt, a hand knob, or a partial-turn fastener.

15. The coating drum apparatus of claim 8, wherein the coating drum rotates about a nozzle apparatus within the coater.

16. The coating drum apparatus of claim 8, further comprising:
a third sidewall having a third length between two opposing open third sidewall ends, the third length different than each of the first length and the second length, wherein the each of the drum end plates is removably connectable to one of the third sidewall ends.

17. A method of operating a coater for coating a material with a solution or a suspension, the method comprising:
assembling a first rotatable drum by connecting each of a pair of removable drum end plates to one of opposing first sidewall ends of a first sidewall having a first length between the opposing first ends;
inserting the first rotatable drum into the coater;
rotating the first rotatable drum to coat the material within the production coater;
removing the first rotatable drum from the coater; and
removing each removable drum end plate for storage of the first sidewall.

18. The method of claim 17, further comprising:
assembling a second rotatable drum by connecting the each of the pair of removable drum end plates to one of opposing second sidewall ends of a second sidewall having a second length between the opposing second sidewall ends, the second length being different than the first length; and
inserting the second rotatable drum into the coater.
